(19) United States
(12) Patent Application Publication
(10) Pub. No.: US 2010/0159884 A1
(43) Pub. Date: Jun. 24, 2010

(54) Method of Determining a Location of a Mobile Device and Method of Managing a List for Use in Such a Method

(75) Inventors: Franklin Selgert, Berkel en Rodenrijs (NL); Antonius Hendrikus Johannes Norp, The Hague (NL)

Correspondence Address: MCDONNELL BOEHNEN HULBERT & BERGHOFF LLP, 300 S. WACKER DRIVE, 32ND FLOOR, CHICAGO, IL, 60606, US

(73) Assignees: Koninklijke KPN N.V., The Hague (NL); Nederlandse organisatie voor Toegepast-Natuurwetenschappelijk Onderzoek TNO, Delft (NL)

(21) Appl. No.: 12/640,256

(22) Filed: Dec. 17, 2009

(30) Foreign Application Priority Data
Dec. 19, 2008 (EP) 08022077.5

(51) Int. Cl. H04W 4/02; H04W 24/00; H04L 12/58; H04W 64/00; H04W 88/02

(52) U.S. Cl. 455/412.1; 455/456.2; 455/414.1; 455/561

(57) ABSTRACT

The invention relates to a method of determining a location of a mobile device for use in a first communication network and a second communication network. The mobile device is camped on a cellular base station in the second communication network. According to the method, a list of records of communication units within the first and/or second communication network that are located within a predetermined geographical area is obtained. A communication unit record contains information representative of the identity of the respective communication unit and information representative of the position of the respective communication unit. Additionally, with the mobile device, communication units within the first and second communication network are detected. Finally, the location of the mobile device is determined based on the information representative of the position of the detected communication units.

### CROSS-REFERENCE TO RELATED APPLICATIONS

The present application claims priority to European Patent Application EP 08022077.5 filed in the EPO Patent Office on Dec. 19, 2008, the entire contents of which are incorporated herein by reference.

### FIELD OF THE INVENTION

The invention relates to a method of determining a location of a mobile device. Additionally, the invention relates to a mobile device using such a method. Furthermore, the invention relates to a method of managing a list of records of communication units located within a coverage area of a cellular base station, and a cellular base station using such a method. Finally, the invention relates to an access point for use in such a method.

### BACKGROUND

Nowadays, the use of mobile devices, e.g. personal digital assistants, portable computers, and mobile phones, for wireless communication purposes is widespread. Furthermore, new applications for these devices emerge rapidly. In many of these new applications, services are provided which relate to functionality to the end user of the mobile device based on its location, so called Location Based Services (LBS). Services include, for example, providing navigational support, providing a local weather forecast, or searching for a nearby restaurant.

Depending on the type of service to be provided, different methods of determining the location of the mobile device can be applied. Some services require very accurate locations, while others only need to know the location in a more general fashion.

Well-known methods of determining the location of a mobile device are based on the location of a base station of the radio cell the mobile device is camped on. In these methods, localization may for example be based on cellular base station identifiers sent by cellular base stations in the network. If the mobile device knows the geographic location of the base stations corresponding to the base station identifiers, it can determine its position. The determination may be done by assuming that the position of the mobile device coincides with the closest base station, by calculating the position using a triangulation technique based on positions of surrounding base stations, or by using other techniques known to a person skilled in the art.

Because the coverage area of a cellular base station is relatively large, the accuracy of the localization will be relatively low. This may become an issue for future mobile device applications, in particular if these applications involve LBS that need a very accurate location determination. Especially in buildings, the location determination can be improved, e.g. to determine on which floor the mobile device is located.

One way to improve the accuracy of the determined position, is to base the location determination on wireless access points, e.g. access points used in a wireless local area network (WLAN). Wireless access points generally have a smaller coverage area than cellular base stations. Furthermore, wireless access points are often located in buildings. By using access point identifiers of wireless access points, Service Set Identifier (SSID) in WLAN, a more precise location determination is possible. A method of determining a location of a mobile device based on wireless access points is described in U.S. Pat. No. 6,968,194. A wireless access point that is equipped to be used in such a method has, for example, been described in European patent application 1802154.

Generally, the coverage of wireless access points is not continuous, but concentrated in so called hotspots. As a result, in some geographical areas, the density of wireless access points is relatively low. Consequently, in these areas, a localization of a mobile device based on a method as described in U.S. Pat. No. 6,968,194 may be less accurate than desired. Thus, a more widely applicable improvement of localization accuracy is desirable.

### SUMMARY

As mentioned above, a further improvement of the reliability of an accurate localization of a mobile device is desired. For this purpose, embodiments of the invention relate to a method A method of determining a location of a mobile device for use in a first communication network and a second communication network, and in communication with a cellular base station in the second communication network, the method comprising:
obtaining a list of records of communication units within the first and/or second communication network that are located within a predetermined geographical area, the communication unit records comprising information representative of the identity of the respective communication units and information representative of the position of the respective communication units;
detecting communication units within the first and second communication network with the mobile device; and
determining the location of the mobile device based on the information representative of the position of the detected communication units.

In embodiments of the invention, the communication unit record further comprises information representative of one or more types of radio technology supported by the respective communication unit. If a mobile device has a general idea with respect to its position, the mobile device may use this information to limit its detection to one or more types of radio technology used by communication units that are expected to be detectable.

The nominal coverage area of a communication unit within the second communication network may be larger than a nominal coverage area of a communication unit within the first communication network. A large coverage area of a communication unit within the second network enables uncomplicated location determination over a large geographical area. A small coverage area of a communication unit within the first network facilitates location determination with high accuracy.

The list may be obtained by receiving the list in response to sending a request for reception of the list to the cellular base station. In this arrangement, the capacity of a broadcast channel of the base station is not burdened unnecessarily. Alternatively, the list may be obtained by reception via a broadcast channel. This arrangement saves time, as the mobile device can obtain the list without a need to send a request and wait for a response.

Embodiments of the invention relate to a mobile device arranged to be part of a first communication network and a second communication network, the mobile device comprising:
a receiver for receiving data from one or more communication units in the first communication network and/or the second communication network;
a memory for storing a list of records of communication units located within a predetermined geographical area; and
a processor for processing data received via the receiver and/or the list stored in the memory;
   wherein the mobile device is arranged to perform embodiments of the aforementioned method.

Embodiments of the invention relate to a method of managing a list for use in a cellular base station, the list comprising records of communication units located within a predetermined geographical area, a communication unit record comprising information representative of the identity of the respective communication units and information representative of the position of the respective communication units, the method comprising:
receiving a message from a communication unit, the message comprising the information representative of the identity of the respective communication unit and information representative of the position of the respective communication unit;
amending the information representative of the position of the communication unit in the list if the information representative of the identity of the communication unit relates to a communication unit being present in the list and the information representative of the position of that communication unit in the list differs from the information representative of the position received in the message; and
adding a record of a communication unit to the list, including the information representative of the identity of the communication unit and the information representative of the position of the communication unit, if the information representative of the identity of the communication unit relates to a communication unit not being present in the list.

The method of managing a list enables the cellular base station to provide a list that represents the most recent communication unit distribution within the predetermined geographical area.

In embodiments of the invention, the communication unit record further comprises information representative of one or more types of radio technology supported by the respective communication unit. If a mobile device, which receives the list managed by the base station, has a general idea with respect to its position, it may use this information to limit its detection of communication units to one or more types of radio technology used by communication units that are expected to be detectable.

Embodiments of the invention relate to a cellular base station comprising:
a receiver for receiving data from one or more communication units in the first communication network and/or the second communication network;
a transmitter for transmitting data towards one or more communication units in the first communication network and/or the second communication network
a database for storing data;
a processor for processing data received via the receiver and/or stored in the memory;
   wherein the base station is arranged to perform embodiments of aforementioned method of managing a list.

The receiver of the base station may be arranged to receive a request from a mobile device for providing the list to the mobile device. The base station may then be arranged to provide the list via the transmitter in response to such request. In this embodiment, the capacity of a broadcast channel of the base station is not burdened unnecessarily. Alternatively, the transmitter of the base station may be arranged to transmit the list via a broadcast channel. Such an embodiment saves time, as the mobile device can obtain the list without a need to send a request and wait for a response.

Finally, embodiments of the invention relate to an access point comprising:
an access point memory storing information representative of an identity of the access point, information representative of a position of the access point; and information representative of one or more types of radio technology supported by the access point;
a receiver for detecting one or more cellular base stations within a second communication network;
a processor for enabling transmission of the access point identifier, the information representative of the position of the access point and the information representative of the one or more types of radio technology supported by the access point to the one or more cellular base stations upon detection.

In embodiments, the access point comprises a position determination unit, e.g. a global positioning system (GPS) receiver, for determining the position of the access point and storing the position in the access point memory. The use of a position determination unit enables the access point to determine its location in a relatively reliable manner.

Further aspects of the invention and embodiments as defined in the claims will be clarified with reference to the attached drawings and corresponding description. It will be understood that the invention is not in anyway restricted to the embodiments disclosed in these drawings.

### BRIEF DESCRIPTION OF THE DRAWINGS

In the drawings:

FIG. 1A schematically depicts an exemplary network architecture for implementation of embodiments of the invention, in which a mobile device is positioned at a first location;

FIG. 1B schematically depicts the network architecture of FIG. 1A, in which a mobile device is positioned at a second location;

FIG. 1C schematically depicts the network architecture of FIG. 1A, in which a mobile device is positioned at a third location;

FIG. 2 schematically depicts a flow diagram of a method of determining a location of a mobile device according to an embodiment of the invention;

FIG. 3 schematically depicts a flow diagram of a method of managing a list for use in a base station according to an embodiment of the invention;

FIG. 4 schematically depicts a mobile device according to an embodiment of the invention;

FIG. 5 schematically depicts an embodiment of a cellular base station that may be used in embodiments of the invention;

FIG. 6 schematically depicts an embodiment of an access point that may be used in embodiments of the invention.

### DETAILED DESCRIPTION

The following is a description of certain embodiments of the invention, given by way of example only.

Throughout the description the term “communication unit” has been used to refer to a unit for communication in a communication network. Communication units include cellular base stations and (wireless) access points.

Additionally, throughout the description, the expression “coverage area” has been used to refer to a geographical area in which signals can be received from a transmitter of a communication unit in a communication network. For clarity reasons, a coverage area of the transmitter has been depicted as a circle. However, it must be understood that the shape of a coverage area as defined above depends on the actual circumstances and may have any other shape. Coverage areas of communication units within a communication network may vary in size, e.g. due to ambient conditions, transmission power settings of the communication unit, etc. For this reason, circles of different radius have been depicted in figures supporting the description.

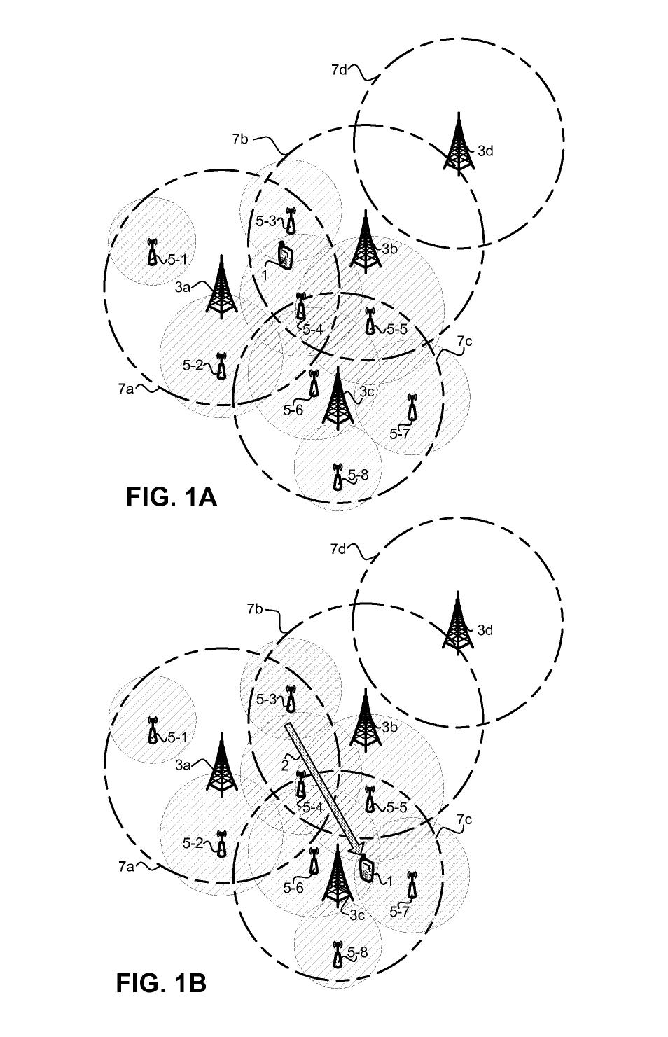

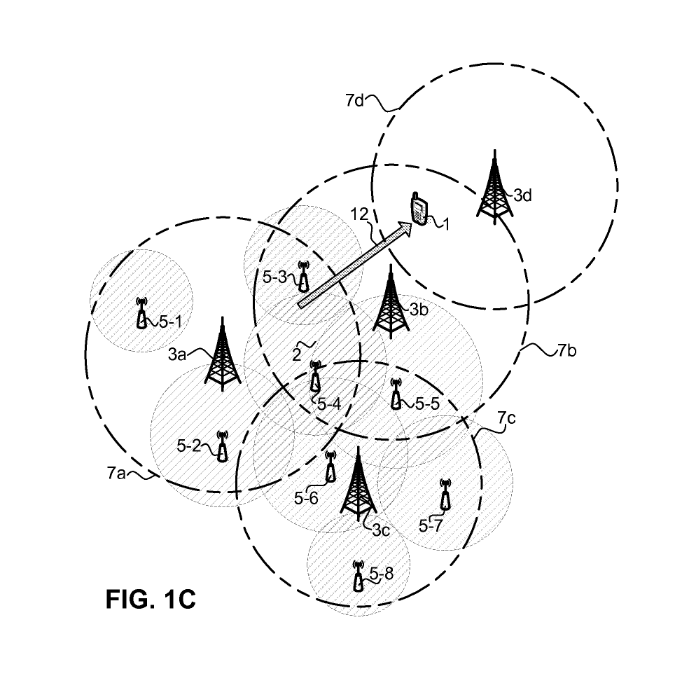

FIGS. 1A and 1B schematically depict an exemplary network architecture for implementation of embodiments of the invention. In FIG. 1A, a mobile device 1 is positioned at a first location. In FIG. 1B, the mobile device 1 is positioned at a second location. The movement of the mobile device 1 from the old location of FIG. 1A to the new location of FIG. 1B is schematically depicted by arrow 2. In FIG. 1C, the mobile device 1 is positioned at a third location. The movement of the mobile device 1 from the old location of FIG. 1A to the new location of FIG. 1C is schematically depicted by arrow 12.

The depicted exemplary network architecture further comprises cellular base stations 3a, 3b, 3c, 3d and a number of access points 5-1 through 5-8, which may be, for example, wireless access points. The base stations 3a, 3b, 3c, 3d have a coverage area 7a, 7b, 7c, 7d respectively. Generally, if the mobile device 1 is positioned within the coverage area of a base station it can communicate with the base station. The access points 5-1 through 5-8 have coverage areas as well, schematically depicted by the dashed circles surrounding each access point. If the mobile device 1 is positioned within the coverage area of an access point, it can generally receive signals from the respective access point.

The access points 5-1 through 5-8 are part of a first communication network. The base stations 3a, 3b, 3c, 3d are part of a second communication network. The mobile device 1 is arranged to be in communication with both the first communication network and the second communication network. Hereinafter the first communication network will be referred to as the first network, and the second communication network will be referred to as the second network.

The first network may be a wireless communication network, and may be arranged to support a first type of radio technology. The first type of radio technology may typically comprise a shorter-range wireless communication technology such as Bluetooth™, Radio Frequency Identification (RFID), WLAN, Worldwide Interoperability for Microwave Access (WIMAX™), Near Field Communication (NFC), Ultra Wide Band (UWB), Zigbee™, Digital Enhanced Cordless Telecommunications (DECT), Wibree™, and other suitable technologies. In the example shown in FIGS. 1A, 1B, the access points 5-1 to 5-8 and the mobile device 1 are equipped with interfaces for communication using the first type of radio technology.

The second network may be arranged to support a second type of radio technology. The second type of radio technology may typically comprise a standard cellular radio technology used for mobile phones, such as Global System for Mobile telecommunications (GSM), Universal Mobile Telecommunications System (UMTS), Wideband Code Division Multiple Access (WCDMA), Long Term Evolution (LTE), Interim Standard 95 (IS-95), Code Division Multiple Access 2000 (CDMA2000), WIMAX, Digital Video Broadcasting (DVB), technologies related to a private mobile radio standard like Terrestrial Trunked Radio (TETRA), technologies related to a satellite communication standard provided by a standard body like the International Mobile Satellite Organization (InMarSat) or other suitable technologies. In the example shown in FIGS. 1A, 1B, the base stations 3a, 3b, 3c, 3d and the mobile device 1 are equipped with interfaces for communication using the second type of radio technology.

It is also possible that the second type of radio technology may be selected from the first list provided above, or that the first type of radio technology may be selected from the second list provided above.

Embodiments of the method of determining a location of a mobile device become more efficient if the nominal coverage area of the access point within the first network is smaller than a nominal coverage area of a base station within the second network. A smaller coverage area of the access point in the first network provides an improved accuracy of position determination. The larger coverage area of the base station within the second network improves the availability of the position determination with improved accuracy.

Embodiments of the invention will be explained with reference to the exemplary network architecture of FIGS. 1A, 1B, 1C.

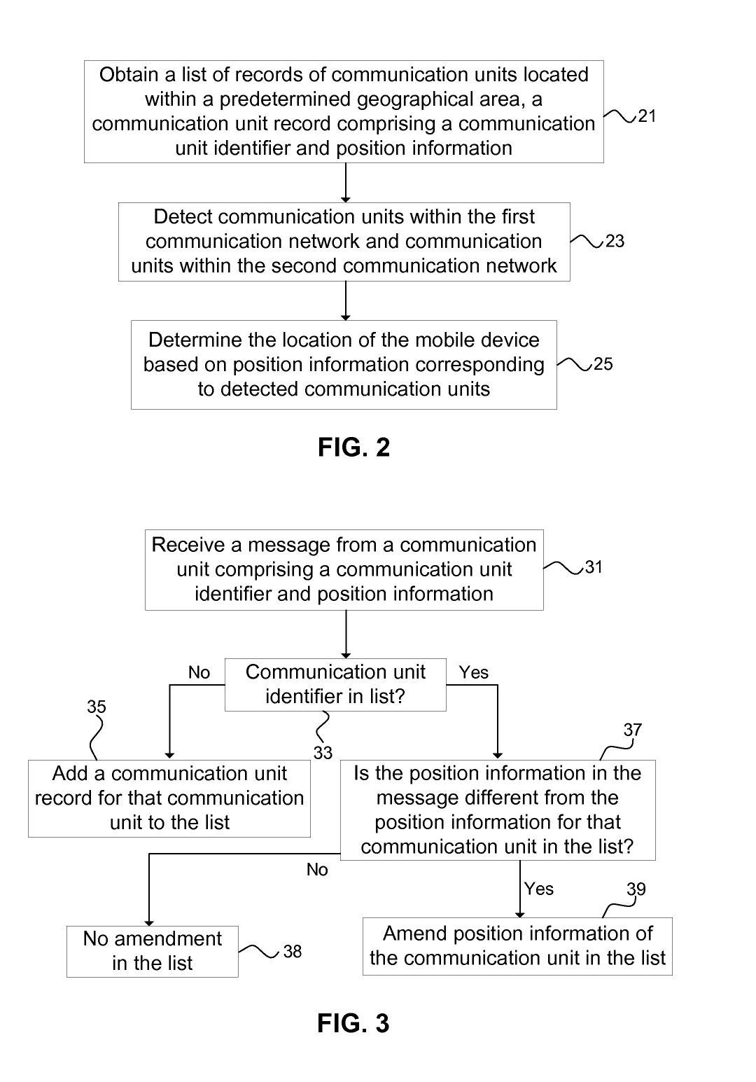

FIG. 2 schematically depicts a flow diagram of an embodiment of a method of determining a location of a mobile device. In action 21, the mobile device obtains a list of records of communication units located within a predetermined geographical area. The predetermined geographical area can relate to a nationwide, regional or local area.

The predetermined geographical area may also correspond to a coverage area of one or more base stations and/or access points.

A communication unit record comprises information representative of the identity of the respective communication unit, hereinafter referred to as communication unit identifier, and information representative of the position of the respective communication unit, hereinafter referred to as position information. The communication unit record may further comprise information representative of the one or more types of radio technology that are supported by the communication unit, hereinafter referred to as radio technology information.

The communication unit identifier may take the form of a Media Access Control (MAC) address, an SSID, or other suitable code for identifying the communication unit. The list of communication unit records may be stored in the mobile device 1.

The position information of the communication unit may be in any format known to a person skilled in the art. For example, such position information may take the form of x- and y-coordinates (optionally also a z-coordinate), longitude-latitude coordinates (optionally an altitude coordinate as well) or relate a certain type of coding, e.g. a postal code or a postal address.

The list may be obtained from the base station the mobile device 1 is camped on, i.e. base station 3a or 3b in the example of FIG. 1A, base station 3c in the example of FIG. 1B, and/or base station 3b or 3d in the example of FIG. 1C. The list may be stored in one of these base stations or may be stored in a data storage node of the network and forwarded to the base stations as needed, e.g. via a fixed network like the Internet or a Public Switched Telephone Network (PSTN).

In action 23, the mobile device 1 detects communication units within the first and second network, i.e. base stations and access points respectively. The mobile device may detect the communication units by scanning for signals transmitted by the communication units. In an embodiment, the detecting comprises determining an identity of a detected communication unit. The identity may be determined based on information provided by a communication unit via a broadcast channel. Alternatively, such information may be provided by the communication unit via a communication interface in response to a signal sent by the mobile device 1.

In an embodiment, the detecting comprises determining a position of a detected communication unit. This can be done to verify a position mentioned in the list. The position of the detected communication unit may be based on information provided by the communication unit via a broadcast channel or via a communication interface in response to a signal sent by the mobile device 1.

If a mobile device 1 has a rough idea with respect to its position, e.g. if it can make an estimate as a result of an earlier determination of its location, and communication records in the list comprise radio technology information, the mobile device 1 may use the list to limit its detection to one or more types of radio technology used by communication units that are expected to be detectable.

Finally, in action 25, a location of the mobile device 1 is determined based on the position information of the communication units detected in action 23.

It should be noted that it is not important whether obtaining the list in action 21 takes place prior to the detecting in action 23 or afterwards. Both the obtaining of the list and the detecting of the communication units should be performed before proceeding to the determining of the location of the mobile device in action 25. For example, the mobile device may be prompted to obtain the list if it detects a base station or access point that is not on the list presently known.

The method of FIG. 2 will now be discussed with reference to the exemplary network architecture depicted in FIGS. 1A, 1B, and 1C. In this example, the predetermined geographical area is taken to correspond to an area covered by at least one of the coverage areas 7a, 7b, 7c, 7d.

In this situation, the list, which includes communication unit records with respect to communication units being part of at least one of the first and second network, may include base station records for base stations 3a, 3b, 3c, 3d and access point records for access points 5-1 through 5-8.

With respect to the first location of the mobile device 1 in FIG. 1A, the mobile device may detect base stations 3a and 3b and access points 5-3 and 5-4. If the mobile device 1 determines its location based solely on the positions of base stations 3a and 3b, the location would not be very accurate due to the base stations' large coverage areas, as can be readily seen in FIG. 1A. If the mobile device 1 determines its location based solely on the positions of the access points 5-3 and 5-4, the error margin would be less, but still not optimal. However, if the positions of both the base stations 3a, 3b and the access points 5-3, 5-4 are used, the accuracy of the determined location is increased still further.

With respect to the second location of the mobile device 1 in FIG. 1B, the mobile device 1 may detect base station 3c and the access points 5-7, 5-9, and 5-10. If the mobile device 1 determines its location solely based on the position of the base station 3c, its determined location would not be accurate. If the mobile device 1 determines its location solely based on the positions of the access points 5-5, 5-6, and 5-7, its determined location would be more accurate, but may still be improved. However, if the positions of both the base station 3c and the access points 5-5, 5-6, and 5-7 are used, the accuracy of the determined location is increased still further.

With respect to the third location of the mobile device 1 in FIG. 1C, the mobile device 1 may detect base stations 3b and 3d. If the location determination of the mobile device 1 would be solely based on detection of access points, the mobile device 1 would be unable to determine its location. However, a mobile device 1 using a method of determining its location based according to an embodiment of the invention would be able to determine its position based on the position of base stations 3b and 3d.

In all situations, the location of the mobile device 1 may be determined in a way known to a person skilled in the art, e.g. a weighed triangulation technique or a technique employing nominal radius of radio technologies supported by the communication units used for the location determination.

As described with respect to FIGS. 1A, 1B, the method of FIG. 2 enables a localization of a mobile device with high accuracy that is widely applicable. The calculation of the location is based on positions of an optimal set or a maximum number of communication units that can be detected by the mobile device.

If more than one base station covers the predetermined geographical area, it is not essential that all base stations manage the list. One base station within the cluster of base stations may be assigned to manage the list such that it remains up to date, and to forward the list to other base stations, preferably via the second network. The other base stations may then store a copy of the list. Alternatively, the list may be stored in a data storage mode of the network, and forwarded as needed. Hereinafter, a base station that manages the list is referred to as a master base station.

Thus, the master base station may be a base station with which the mobile device 1 has established an active communication link, e.g. base station 3c in FIG. 1B. In this case, a direct communication link is established between the master base station and the mobile device.

Alternatively, a base station without a direct communication link with the mobile device 1 may serve as master base station. In that case, the mobile device 1 may receive a copy of the list from the base station on which it is camped.

The obtaining in action 21 may comprise a sending to a base station of a request for reception of the list. In response to this request, the list is received by the mobile device 1 from the base station. The request may be sent to any base station within the predetermined geographical area. If the request is sent to a base station that does not have a copy of the list available, the base station will arrange a copy of the list in response to the request sent by the mobile device, and forward the list upon reception to the mobile device 1.

Alternatively, the obtaining in action 21 may include receiving the list via a broadcast channel. In this case, all or some of the base stations may be arranged to broadcast the list via such a broadcast channel.

It can be readily understood that the method of determining a location of a mobile device as described with reference to FIGS. 1 and 2 benefits from a list that is up to date. That is, the list should represent the positions of all communication units within the predetermined geographical area at the moment of obtaining as well as possible, and should include recent changes.

Generally, within the predetermined geographical area, the number and locations of communication units varies. For example, new communication units may be activated or existing communication units may be deactivated, communication units may change location within the predetermined geographical area, or communication units may be moved inside or outside the predetermined geographical area. Therefore, it is desirable to manage the list so as to be able to provide a list that represents the most recent communication unit distribution within the predetermined geographical area.

FIG. 3 schematically depicts a flow diagram of a method of managing a list for use in a base station, the list comprising records of communication units located within a predetermined geographical area according to an embodiment of the invention. The base station may take the form of the base station 50 discussed with reference to FIG. 5.

In action 31, the base station receives a message from a communication unit. The message comprises a communication unit identifier and position information. The base station is part of the second network, but may receive a message regarding the identity and position of access points within the first network and base stations within the second network.

In action 33, the base station checks whether the communication unit identifier of the communication unit is present in the list.

If the communication unit identifier is not present in the list, a communication unit record including the communication unit identifier and the position information of that communication unit is added to the list in action 35. On the other hand, if the communication unit identifier is present in the list, the method proceeds to action 37, in which the position information regarding the respective communication unit in the message is compared with the position information stored in the list for that respective communication unit.

If the position information for a communication unit in the message is different from the position information for the same communication unit in the list, the base station amends the position information of that communication unit in the list in action 38. On the other hand, if the position information in the message is the same as the position information in the list, no amendment is made, schematically represented in FIG. 3 as action 39. It should be understood that “no amendment” includes a replacement of all data in a record, where the new data being stored is similar to the data being replaced. In such a case a timestamp may be updated. In embodiments of the invention, amendments are only made conditionally, e.g. only if the information provided in the message is considered to have a minimum reliability.

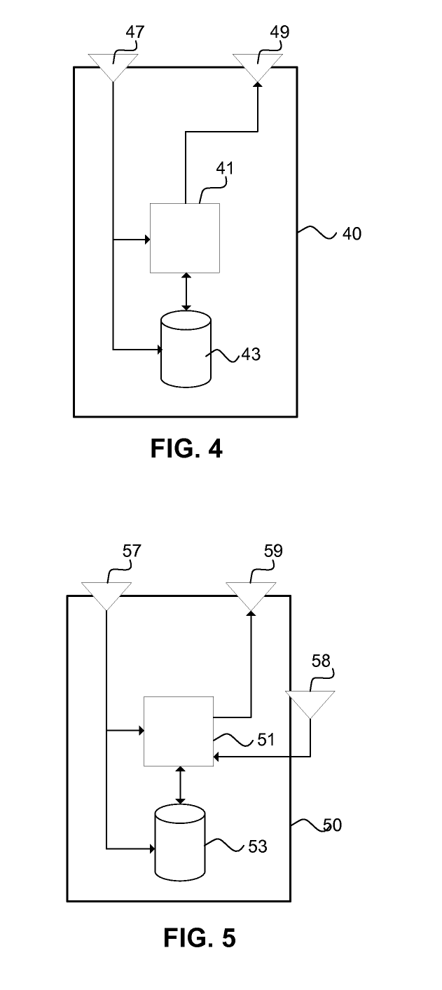

FIG. 4 schematically depicts an embodiment of a mobile device 40 according to an embodiment of the invention. The mobile device 40 is arranged to perform embodiments of a method of determining a location of a mobile device in the first network, e.g. the method schematically depicted in and explained with reference to FIG. 2. The mobile device comprises a processor 41, a memory 43, and a receiver 47.

The processor 41 is communicatively coupled to the memory 43. The processor 41 may comprise a control unit to control signals received by the receiver 47, e.g. for the purpose of controlling detection. The receiver 47 may be arranged to operate within the first network and the second network. Alternatively, the mobile device 40 may comprise two receivers, a first receiver arranged to operate within the first network and a second receiver arranged to operate within the second network.

In embodiments of the invention, the mobile device 40 may further comprise a transmitter 49. In such embodiment, the processor 41 may be arranged to control signals to be sent via the transmitter 49.

FIG. 5 schematically depicts an embodiment of a primary base station 50 that may be used in embodiments of the invention, i.e. as base station 3a, 3b or 3c in FIGS. 1A, 1B. The base station 50 of FIG. 5 may further be used to implement a method of managing a list for use in the base station, the list comprising records of communication units located within a predetermined geographical area. An embodiment of such a method of managing has been discussed with reference to FIG. 3.

The base station 50 comprises a processor 51 communicatively coupled to a database 53. In the database 53, a list of records of communication units may be stored, the communication units being located within a predetermined geographical area. A communication unit record comprises a communication unit identifier and position information. The communication unit record may further comprise radio technology information corresponding to the respective communication unit.

The base station 50 further comprises a receiver 57 and a transmitter 59. The receiver 57 and the transmitter 59 are arranged to communicate via a communication interface within the second network, and may be able to communicate via a communication interface within the first network as well. In embodiments, the cellular base station 50 may further comprise a further receiver 58. The further receiver 58 may be connected to a fixed network, e.g. Internet or a PSTN.

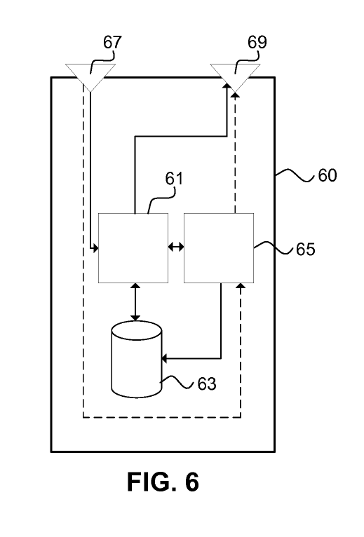

FIG. 6 schematically depicts an embodiment of an access point 60 that may be used in embodiments of the present invention. The access point 60 comprises a processor 61, a memory 63, a receiver 67, and a transmitter 69.

The receiver 67 may be arranged to receive signals from a mobile device. The receiver 67 may further be arranged to detect one or more base stations within the second network.

The transmitter 69 may be arranged to transmit the access point identifier and position information to one or more detected base stations. If the respective base station is part of the first network and located within the coverage area of the access point 60, the access point identifier and position information may be sent via a communication interface within the first network. Alternatively, the access point 60 may be part of the second network, and the transmitter 69 may be arranged to transmit the access point identifier and position information via a communication interface within the second network.

The processor 61 may comprise a control unit to control signals received by the receiver 67 and signals to be sent via the transmitter 69, e.g. for the purpose of controlling detection of base stations or for the purpose of responding to signals received from a mobile device. Alternatively, or additionally, the processor 61 may enable transmission of the access point identifier and position information of the access point in a different way, e.g. by transmission via a fixed network like Internet or a PSTN.

The access point memory 63 is configured to store or stores an access point identifier and position information of the access point 60. The access point identifier may already have been stored in the access point memory 63 at the time of manufacturing. The position information of the access point 60 may be provided via a user interface (not shown), e.g. via a keyboard, touch screen, etc. The access point memory 63 may further be configured to store or stores radio technology information. In such a case, the radio technology information may be transmitted via transmitter 69 controlled by the processor 61 as described earlier.

In an embodiment, the access point 60 further comprises a position determination unit 65 for determining the position of the access point 60. The position determination unit 65 may make use of the receiver 67 and the transmitter 69 of the access point 60. If the position has been determined, the position may be stored in the access point memory 63. The location determination unit may comprise a global positioning system (GPS) receiver.

In FIG. 6, data transferred in view of the determining of a position by means of a position determination unit has been shown with the dashed arrows. Data related to the scanning action, has been depicted by means of the solid arrows.

It must be understood that although embodiments of the invention have been described with reference to two different types of networks, the invention is not limited to this number. Thus, in embodiments of the invention more than two different cellular communication networks may be applied.

The invention has been described by reference to certain embodiments discussed above. It will be recognized that these embodiments are susceptible to various modifications and alternative forms well known to those of skill in the art.

### Abbreviations

### CDMA2000 Code Division Multiple Access 2000

### DECT Digital Enhanced Cordless Telecommunications

### DVB Digital Video Broadcasting

GSM Global System for Mobile telecommunications

### InMarSat International Mobile Satellite Organization

### IS-95 Interim Standard 95

### LBS Location Based Services

### LTE Long Term Evolution

### MAC Media Access Control

### NFC Near Field Communication

### RFID Radio Frequency Identification

### SSID Service Set Identifier

### TETRA Terrestrial Trunked Radio

### UMTS Universal Mobile Telecommunications System

### UWB Ultra Wide Band

### WCDMA Wideband Code Division Multiple Access

### WIMAX Worldwide Interoperability for Microwave Access

WLAN Wireless Local Area Network

1. A method of determining a location of a mobile device for use in a first communication network and a second communication network, and in communication with a cellular base station in the second communication network, the method comprising:
the mobile device obtaining a list of records of communication units within the first and/or second communication network that are located within a predetermined geographical area, the communication unit records comprising information representative of the identity of the respective communication units and information representative of the position of the respective communication units;
the mobile device detecting communication units within the first and second communication network; and
the mobile device determining the location of the mobile device based on the information representative of the position of the detected communication units.

2. The method of claim 1, wherein the communication unit record further comprises information representative of one or more types of radio technology supported by each respective communication unit.

3. The method of claim 1, wherein a nominal coverage area of a communication unit within the second communication network is larger than a nominal coverage area of a communication unit within the first communication network.

4. The method of claim 1, wherein said obtaining comprises:
the mobile device sending a request for reception of said list to the cellular base station; and
the mobile device receiving said list in response.

5. The method of claim 1, wherein said obtaining comprises receiving said list of records of communication units located within a predetermined geographical area via a broadcast transmission.

6. The method of claim 1, wherein said detecting comprises determining an identity of a detected communication unit.

7. A mobile device arranged to be part of a first communication network and a second communication network, the mobile device comprising:
a receiver for receiving data from one or more communication units in the first communication network and/or the second communication network;
a memory for storing a list of records of communication units located within a predetermined geographical area; and
a processor for processing data received via said receiver and/or the list stored in said memory and further configured to:
obtain a list of records of communication units within the first and/or second communication network that are located within a predetermined geographical area, the communication unit records comprising information representative of the identity of the respective communication units and information representative of the position of the respective communication units;
detect communication units within the first and second communication network; and
determine the location of the mobile device based on the information representative of the position of the detected communication units.

8. The mobile device of claim 7, wherein the communication unit record further comprises information representative of one or more types of radio technology supported by each respective communication unit.

9. The mobile device of claim 7, wherein a nominal coverage area of a communication unit within the second communication network is larger than a nominal coverage area of a communication unit within the first communication network.

10. The mobile device of claim 7, wherein the processor is further configured to:
send a request for reception of said list to the cellular base station; and
receive said list in response.

11. The mobile device of claim 7, wherein the processor is further configured to receive said list of records of communication units located within a predetermined geographical area via a broadcast transmission.

12. The mobile device of claim 7, wherein the processor is further configured to determine an identity of a detected communication unit.

13. A method of managing a list stored in a cellular base station, the list comprising records of communication units located within a predetermined geographical area, the communication unit records comprising information representative of an identity of each respective communication unit and information representative of a position of each respective communication unit, the method comprising:
receiving a message from a communication unit, the message comprising the information representative of the identity of the respective communication unit and information representative of the position of the respective communication unit;
amending the information representative of the position of the communication unit in said list if the information representative of the identity of the communication unit relates to a communication unit already present in the list and if the information representative of the position of that communication unit in the list differs from the information representative of the position received in the message; and
adding a record of the communication unit to the list including the information representative of the identity of the communication unit and the information representative of the position of the communication unit, if the information representative of the identity of the communication unit relates to a communication unit not already present in the list.

14. The method of claim 13, wherein the message further comprises information representative of one or more types of radio technology supported by the respective communication unit, and wherein said amending is further performed if the radio type information in the list differs from the radio type information in the message for the communication unit, and wherein adding said record includes adding the radio type information of the communication unit.

15. A cellular base station comprising:
a receiver for receiving data from one or more communication units in the first communication network and/or the second communication network;
a transmitter for transmitting data to one or more communication units in the first communication network and/or the second communication network;
a database for storing data including a list of communication unit information; and
a processor for processing data received via said receiver and/or stored in said memory, and further configured to:
receive a message from a communication unit, the message comprising the information representative of the identity of the respective communication unit and information representative of the position of the respective communication unit;
amend the information representative of the position of the communication unit in said list if the information representative of the identity of the communication unit relates to a communication unit already present in the list and if the information representative of the position of that communication unit in the list differs from the information representative of the position received in the message; and
add a record of the communication unit to the list including the information representative of the identity of the communication unit and the information representative of the position of the communication unit, if the information representative of the identity of the communication unit relates to a communication unit not already present in the list.

16. The cellular base station of claim 15, wherein the message further comprises information representative of one or more types of radio technology supported by the respective communication unit, and wherein said amending is further performed if the radio type information in the list differs from the radio type information in the message for the communication unit, and wherein adding said record includes adding the radio type information of the communication unit.

17. The cellular base station of claim 15, wherein the transmitter is further arranged to transmit said list via a broadcast transmission.

18. The cellular base station of claim 15, wherein the receiver is further arranged to receive a request from a mobile device for providing the list to the mobile device, and the processor is further configured to provide said list via said transmitter in response to said request.

19. An access point operating as a member of a first communication network and comprising:
a memory storing information representative of an identity of the access point, information representative of a position of the access point, and information representative of one or more types of radio technology supported by the access point;
a receiver for detecting one or more cellular base stations within a second communication network;
a processor for enabling transmission of said access point identifier, said information representative of the position of the access point, and said information representative of the one or more types of radio technology supported by the access point to said one or more cellular base stations upon detection.

20. The access point of claim 19, further comprising a position determination unit for determining the position of the access point and storing the determined position in the memory.

21. The access point of claim 20, wherein said position determination unit comprises a global positioning system (GPS) receiver.
